(19) United States
(12) Patent Application Publication
(10) Pub. No.: US 2023/0286452 A1
(43) Pub. Date: Sep. 14, 2023

(54) UNDERCARRIAGE WIRING MODULE AND ROUTING STRUCTURE OF UNDERCARRIAGE WIRING MODULE

(71) Applicant: SUMITOMO WIRING SYSTEMS, LTD., Yokkaichi-shi, Mie (JP)

(72) Inventors: Takahiro MURATA, Yokkaichi-shi (JP); Naofumi YAMATAKE, Yokkaichi-shi (JP)

(73) Assignee: SUMITOMO WIRING SYSTEMS, LTD., Yokkaichi-shi, Mie (JP)

(21) Appl. No.: 18/013,943

(22) PCT Filed: Jul. 9, 2021
(86) PCT No.: PCT/JP2021/025916

§ 371 Date: Dec. 30, 2022

(30) Foreign Application Priority Data
Jul. 13, 2020 (JP) 2020-119752

(51) Int. Cl. B60R 16/027; B60R 16/02; B60R 16/023

(52) U.S. Cl. CPC B60R 16/027; B60R 16/0207; B60R 16/0239; H02G 3/30

(57) ABSTRACT

An undercarriage wiring module includes: a wiring member connecting a vehicle body side apparatus and a vehicle wheel side apparatus; and a support member supporting the wiring member, wherein the wiring member includes a first wire-like transmission member and a second wire-like transmission member thinner than the first wire-like transmission member, and the support member supports the wiring member so that the first wire-like transmission member is located closer to a steering rotation central axis than the second wire-like transmission member in at least a part of the wiring member.

### TECHNICAL FIELD

The present disclosure relates to an undercarriage wiring module and a routing structure of an undercarriage wiring module.

### BACKGROUND ART

Patent Document 1 discloses a power cable for an in-wheel motor. Ends of three power cables on a side of a vehicle body are clamped by a clamp member. Ends of three power cables on a side of a motor are connected to a power cable terminal box provided to an in-wheel motor drive device.

### PRIOR ART DOCUMENTS

### Patent Document(s)

Patent Document 1: Japanese Patent Application Laid-Open No. 2018-65545

### SUMMARY

### Problem to Be Solved by the Invention

The undercarriage wiring module such as the power cable for the in-wheel motor disclosed in Patent Document 1 is repetitively deformed in accordance with a rotation of a vehicle wheel with steering.

Demanded is further improvement of resistance of the undercarriage wiring module to the repetitive deformation.

Accordingly, an object of the present disclosure is to further improve resistance of an undercarriage wiring module to repetitive deformation.

### Means to Solve the Problem

An undercarriage wiring module according to the present disclosure is an undercarriage wiring module including: a wiring member connecting a vehicle body side apparatus and a vehicle wheel side apparatus; and a support member supporting the wiring member, wherein the wiring member includes at least one first wire-like transmission member and a second wire-like transmission member thinner than the first wire-like transmission member, and the support member supports the wiring member so that the first wire-like transmission member is located closer to a steering rotation central axis than the second wire-like transmission member in at least a part of the wiring member.

A routing structure of an undercarriage wiring module according to the present disclosure is a routing structure of an undercarriage wiring module including a wiring member connecting a vehicle body side apparatus and a vehicle wheel side apparatus, and a part of the wiring member is routed to go through a steering rotation central axis.

### Effects of the Invention

According to the present disclosure, resistance of the undercarriage wiring module to repetitive modification is further improved.

### BRIEF DESCRIPTION OF DRAWINGS

FIG. 1 is a schematic cross-sectional view illustrating a routing structure of an undercarriage wiring module according to an embodiment.

FIG. 2 is a II-II line schematic cross-sectional view in FIG. 1.

FIG. 3 is a schematic cross-sectional view along a III-III line in FIG. 1.

FIG. 4 is a cross-sectional view illustrating a wiring member according to a modification example.

FIG. 5 is a cross-sectional view illustrating a wiring member according to a modification example.

FIG. 6 is a cross-sectional view illustrating a wiring member according to a modification example.

FIG. 7 is a cross-sectional view illustrating a wiring member according to a modification example.

FIG. 8 is a cross-sectional view illustrating a wiring member according to a modification example.

FIG. 9 is a cross-sectional view illustrating a wiring member according to a modification example.

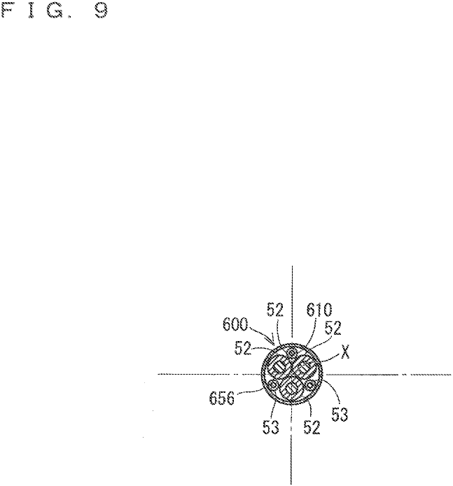

FIG. 10 is a cross-sectional view illustrating a support member according to a modification example.

### DESCRIPTION OF EMBODIMENT(S)

### [Description of Embodiment of Present Disclosure]

Embodiments of the present disclosure are listed and described firstly.

An undercarriage wiring module according to the present disclosure is as follows.

(1) An undercarriage wiring module includes: a wiring member connecting a vehicle body side apparatus and a vehicle wheel side apparatus; and a support member supporting the wiring member, wherein the wiring member includes at least one first wire-like transmission member and a second wire-like transmission member thinner than the first wire-like transmission member, and the support member supports the wiring member so that the first wire-like transmission member is located closer to a steering rotation central axis than the second wire-like transmission member in at least a part of the wiring member. According to the undercarriage wiring module, when the vehicle wheel is rotated around the steering rotation axis, the thick first wire-like transmission member is hardly bended and deformed, and the thin second wire-like transmission member is bended and deformed more easily than the first wire-like transmission member. Accordingly, the resistance of the undercarriage wiring module to the repetitive bending deformation is further improved as the whole undercarriage wiring module.

(2) The undercarriage wiring module according to (1), it is applicable that the support member supports the wiring member so that at least a part of the wiring member is parallel to the steering rotation central axis, and the first wire-like transmission member is located closer to the steering rotation central axis than the second wire-like transmission member in a portion of the wiring member parallel to the steering rotation central axis. When the vehicle wheel is rotated around the steering rotation central axis, the first wire-like transmission member close to the steering rotation central axis is easily bended and deformed in a portion of the wiring member parallel to the steering rotation central axis.

(3) The undercarriage wiring module according to (1) or (2), it is applicable that the support member supports the wiring member so that at least a part of the wiring member extends along the steering rotation central axis, and the first wire-like transmission member is located closer to the steering rotation central axis than the second wire-like transmission member in a portion of the wiring member extending along the steering rotation central axis. A portion of the wiring member extending along the steering rotation central axis can be twisted in accordance with the rotation of the vehicle wheel with steering, thus the bending deformation of the wiring member is suppressed. Particularly, the thick first wire-like transmission member is twisted, thereby being able to extend along the rotation of the vehicle wheel, thus is hardly deteriorated. Accordingly, the resistance to the repetitive deformation is further improved as the whole undercarriage wiring module.

(4) The undercarriage wiring module according to (3), the steering rotation central axis may pass through an area in a minimum inclusion circle in a transverse-sectional surface of the wiring member in a portion of the wiring member extending along the steering rotation central axis.

(5) The undercarriage wiring module according to any one of (1) to (4), it is applicable that the first wire-like transmission member is a power source wire, and the second wire-like transmission member is a signal wire. The thick power source wire is hardly bended and deformed, and the thin second wire-like transmission member is bended and deformed more easily than the first wire-like transmission member. Thus, the resistance of the undercarriage wiring module to the repetitive bending deformation is further improved as the whole undercarriage wiring module.

(6) The undercarriage wiring module according any one of (1) to (5), it is applicable that the wiring member includes the plurality of first wire-like transmission members, the plurality of first wire-like transmission members are bundled in at least a part of the wiring member, and the second wire-like transmission member is fitted in a gap between the plurality of first wire-like transmission members in a position farther away from the steering rotation central axis than the plurality of first wire-like transmission members. The plurality of first wire-like transmission members can be disposed closer to the steering rotation central axis than the second wire-like transmission member while thinning the wiring member.

A routing structure of an undercarriage wiring module according to the present disclosure is as follows.

(7) A routing structure of an undercarriage wiring module includes a wiring member connecting a vehicle body side apparatus and a vehicle wheel side apparatus, and a part of the wiring member is routed to go through a steering rotation central axis. According to the undercarriage wiring module, when the vehicle wheel is rotated around the steering rotation axis, the thick first wire-like transmission member is hardly bended and deformed, and the thin second wire-like transmission member is bended and deformed more easily than the first wire-like transmission member. Accordingly, the resistance of the undercarriage wiring module to the repetitive bending deformation is further improved as the whole undercarriage wiring module.

### [Details of Embodiment of Present Disclosure]

An undercarriage wiring module and a routing structure of an undercarriage wiring module according to the present disclosure are described with reference to the drawings. The present disclosure is not limited to these examples, but is indicated by claims, and it is intended that meanings equivalent to claims and all modifications within a scope of claims are included.

### [Embodiment]

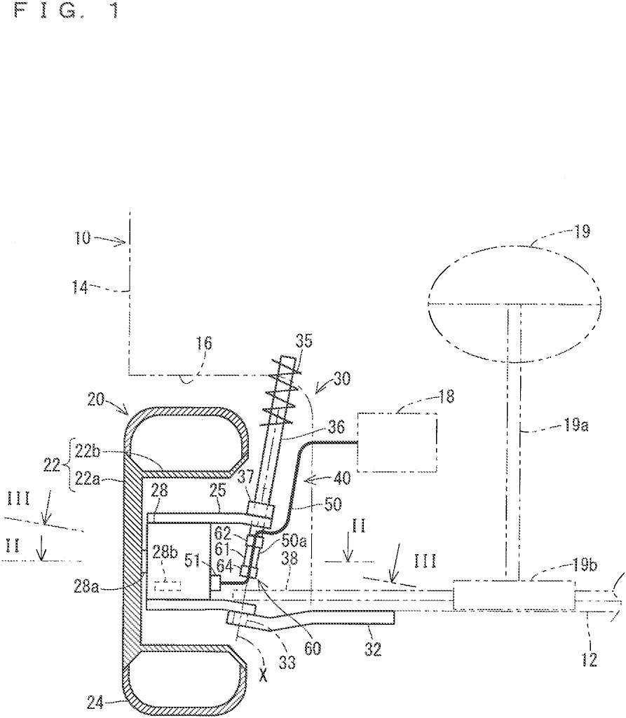

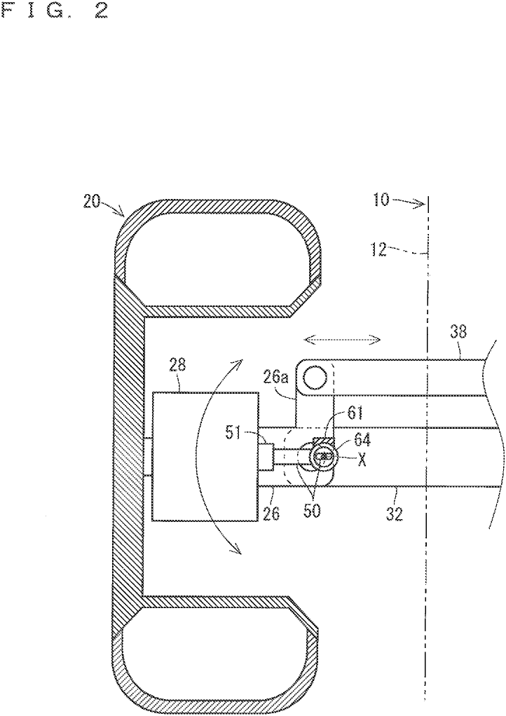

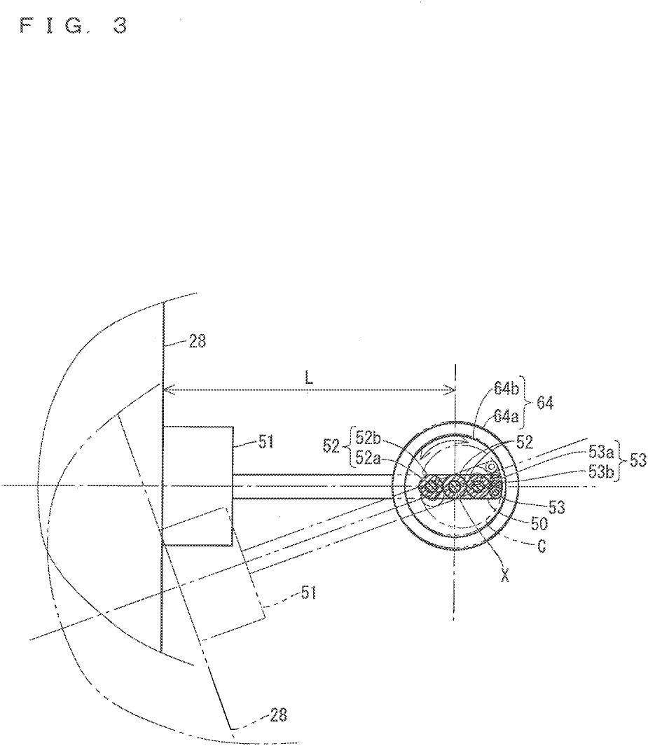

An undercarriage wiring module and a routing structure of an undercarriage wiring module according to an embodiment are described hereinafter. FIG. 1 is a schematic cross-sectional view illustrating a routing structure 30 of an undercarriage wiring module 40. FIG. 1 is a schematic cross-sectional view of a plane perpendicular to a front-back direction of a vehicle body 10 and passing through a central axis of a vehicle wheel 20. FIG. 2 is a II-II line schematic cross-sectional view in FIG. 1. FIG. 3 is a schematic cross-sectional view along a III-III line in FIG. 1. FIG. 2 mainly illustrates a portion around the vehicle wheel 20. FIG. 3 mainly illustrates a relationship between a steering rotation central axis X, a wiring member 50, and a vehicle wheel side apparatus.

The undercarriage wiring module 40 includes the wiring member 50 and a support member 60. The wiring member 50 is a wiring member connecting a vehicle body side apparatus 18 and a vehicle wheel side apparatus 28. The wiring member 50 is routed along a route connecting the vehicle body side apparatus 18 and the vehicle wheel side apparatus 28. The support member 60 is a member supporting the wiring member 50.

A configuration of a portion where the undercarriage wiring module 40 is routed is described for convenience of description.

The vehicle body 10 in which a part of the undercarriage wiring module 40 is routed is a vehicle body of an automobile. FIG. 1 illustrates a portion around the vehicle wheel 20 on a front side in the vehicle body 10. The undercarriage wiring module 40 is assumed to be used for the vehicle wheel 20 steered with steering. For example, the vehicle wheel 20 is a front wheel. The undercarriage wiring module may be used for a rear wheel when the rear wheel is steered.

The vehicle body 10 includes a floor part 12 and a body part 14. The floor part 12 is a portion facing a ground. The body part 14 is provided to an upper side of the floor part 12 to constitute an exterior of the vehicle body 10. The vehicle body 10 may be a monocoque body made up of a frame and a body as rigid bodies integrated with each other, or may have a configuration in which a body is mounted on a frame. In the present embodiment, a travel direction in a case where an automobile normally travels is referred to as a front, and a side opposite thereto is referred to as a back in some cases.

The vehicle wheel 20 is rotatably supported on the vehicle body 10. In the example illustrated in FIG. 1, the vehicle wheel 20 is rotatably supported in a fender apron 16. Any suspension type such as an independent suspension type, for example, may be applied to a suspension device to support the vehicle wheel 20. FIG. 1 illustrates an example that a lower arm 32 and a dumper 36 support the vehicle wheel 20. A suspension device illustrated in FIG. 1 is an example of a strut-type suspension device.

More specifically, the vehicle wheel 20 includes a wheel 22 and a tire 24. The wheel 22 is formed of metal such as iron or aluminum. The wheel 22 includes a disk part 22a and a tire attachment part 22b. The disk part 22a is formed into a circular plate-like shape. The tire attachment part 22b is an annular portion protruding from a surrounding area of the disk part 22a to an inner side in a vehicle width direction. An annular rim protrudes on both side edges of the tire attachment part 22b. The tire 24 formed by an elastic member such as rubber is attached to an outer periphery of the tire attachment part 22b described above.

The vehicle wheel side apparatus 28 is provided to the vehicle wheel 20 described above. Description herein is based on an assumption that the vehicle wheel side apparatus 28 is an in-wheel motor. The in-wheel motor is a motor for traveling incorporated into the vehicle wheel 20 to rotate the vehicle wheel 20. Herein, a shaft 28a of the vehicle wheel side apparatus (in-wheel motor) 28 is connected to a central portion of the disk part 22a while the vehicle wheel side apparatus 28 is disposed in the tire attachment part 22b. Accordingly, the vehicle wheel side apparatus 28 is integrally incorporated into the vehicle wheel 20.

An upper knuckle part 25 and a lower knuckle part 26 are attached to the vehicle wheel side apparatus 28. The upper knuckle part 25 extends toward an inner side in the vehicle width direction from an upper portion of the vehicle wheel side apparatus 28. The lower knuckle part 26 extends toward the inner side in the vehicle width direction from a lower portion of the vehicle wheel side apparatus 28. An arm part 26a receiving force of steering is provided to protrude on the lower knuckle part 26. Herein, the arm part 26a extends backward from the inner side in the vehicle width direction in the lower knuckle part 26. When the vehicle wheel side apparatus 28 is not the in-wheel motor, the upper knuckle part 25 and the lower knuckle part 26 described above extend to the inner side in the vehicle width direction from a bearing part rotatably supporting the vehicle wheel 20 in some cases.

The lower arm 32 is a member formed by metal, for example. A base end portion of the lower arm 32 is swingably supported on the floor part 12 in a position on the inner side in the vehicle width direction of the vehicle wheel 20. The axis as a center of swing of the base end portion of the lower arm 32 extends in a front-back direction of the vehicle body 10. The base end portion of the lower arm may be swingably supported on the floor part on an obliquely front side, an inner side, an obliquely back side, or a back side of the vehicle wheel. In these cases, a rotational axis of the swing of the lower arm may extend in a right-left direction of the vehicle body, a front-back direction, or an oblique direction with respect to both the right-left direction and the front-back direction.

A tip end portion of the lower arm 32 extends toward an inner side of the fender apron 16 (herein, toward an outer side in the vehicle width direction) from the floor part 12. A bearing part 33 is provided to the tip end portion of the lower arm 32. The lower knuckle part 26 is rotatably supported on the tip end portion of the lower arm 32 via the bearing part 33. A rotational axis of the bearing part 33 is the steering rotation central axis X around which the vehicle wheel 20 is rotated in the fender apron 16.

The spring 35 and the dumper 36 are provided between the upper knuckle part 25 and the vehicle body 10. More specifically, an upper end portion of the dumper 36 is supported on the vehicle body 10 on an upper side of the vehicle wheel 20. The upper knuckle part 25 is rotatably supported on the lower end portion of the dumper 36 via a bearing part 37. A rotational axis of the bearing part 37 is the steering rotation central axis X around which the vehicle wheel 20 is rotated in the fender apron 16.

As described above, the base end portion of the lower arm 32 is swingably supported on the floor part 12, thus the lower arm 32 supports the vehicle wheel 20 to be movable in an up-down direction in the fender apron 16. The dumper 36 intervenes between the upper knuckle part 25 and the vehicle body 10 while a movement direction of the vehicle wheel 20 is regulated by the lower arm 32. The dumper 36 and the spring 35 externally mounted to the dumper 36 absorb impact by concave-convex portions of a road surface in traveling.

In the present embodiment, a rotational axis of the bearing part 33 and a rotational axis of the bearing part 37 are located on the steering rotation central axis X of the vehicle wheel 20. A central axis of the dumper 36 is also located on the steering rotation central axis X of the vehicle wheel 20. The central axis of the dumper and the steering rotation central axis X need not coincide with each other.

A tie rod 38 is connected to a tip end portion of the arm part 26a. When a steering wheel 19 is rotated with steering by a driver, a rotational movement thereof is transmitted to the tie rod 38 as a movement in the vehicle width direction via a transmission mechanism 19b such as a steering shaft 19a and a rack-and-pinion mechanism. When the tie rod 38 is moved in the vehicle width direction, the lower knuckle part 26 can be rotated around the rotational axis of the bearing part 33 (that is to say, the steering rotation central axis X). Accordingly, the vehicle wheel 20 can be rotated around the steering rotation central axis X with the steering. A travel direction of the vehicle body 10 is changed by the rotation of the vehicle wheel 20 around the steering rotation central axis X. That is to say, the steering rotation central axis X may be a central axis around which the vehicle wheel 20 is rotated by an operation of the steering wheel 19. The steering rotation central axis X may also be considered an axis closer to a gravity direction than a horizontal direction. The steering rotation central axis X may also be considered a central axis around which the vehicle wheel 20 is rotated to change the travel direction of the vehicle body 10.

The vehicle body side apparatus 18 is provided to a side of the vehicle body 10, and the vehicle wheel side apparatus 28 is provided to a side of the vehicle wheel 20. The vehicle wheel side apparatus 28 is an apparatus incorporated into the vehicle wheel 20 and rotated around the steering rotation central axis X together with the vehicle wheel 20 with respect to the vehicle body 10. As described above, when the vehicle wheel side apparatus 28 is assumed to be the in-wheel motor, the vehicle body side apparatus 18 is assumed to be a drive unit driving the in-wheel motor. For example, when the in-wheel motor is a three-phase induction motor, the vehicle body side apparatus 18 is assumed to be an inverter unit for supplying three-phase alternating current of U phase, V phase, and W phase for driving the in-wheel motor. The vehicle body side apparatus 18 is an apparatus which is provided to the vehicle body 10, and is not rotated even when the vehicle wheel 20 is rotated around the steering rotation central axis X.

The vehicle wheel side apparatus 28 is not necessarily the in-wheel motor. The vehicle wheel side apparatus 28 is assumed to be a sensor or an electrical brake, for example, in place of or in addition to the in-wheel motor. For example, the sensor may be a sensor detecting a rotational speed of a vehicle wheel or a temperature sensor detecting a temperature of an in-wheel motor. The vehicle wheel side apparatus 28 may be an electrical brake including a motor, for example, and performing braking on the rotation of the vehicle wheel 20 using electricity as power. The electrical brake may be an electrical parking brake used in parking or stopping an automobile or a brake used in traveling of an automobile. It is sufficient that the vehicle body side apparatus 18 is an apparatus transmitting or receiving a signal between these vehicle wheel side apparatuses 28 or supplying electrical power. For example, the vehicle body side apparatus 18 may include a function as an electronic control unit (ECU) receiving a signal from a sensor or controlling the electrical brake described above. The vehicle body side apparatus 18 may be provided inside or outside the vehicle body 10. Herein, the vehicle body side apparatus 18 is provided inside the vehicle body 10.

The wiring member 50 includes a first wire-like transmission member 52 and a second wire-like transmission member 53. One end portion of the wiring member 50 is connected to the vehicle body side apparatus 18. The other end portion of the wiring member 50 is connected to the vehicle wheel side apparatus 28. The first wire-like transmission member 52 and the second wire-like transmission member 53 are wire-like members transmitting an electrical power or light, for example. The second wire-like transmission member 53 is thinner than the first wire-like transmission member 52. Illustrated herein is an example that the first wire-like transmission member 52 is the power source wire 52, and the second wire-like transmission member 53 is the signal wire 53 (refer to FIG. 3). The power source wire 52 is an electrical wire in which a covering 52b is formed around a core wire 52a. The power source wire 52 is a power source wire supplying three-phase alternating current to the in-wheel motor, for example, and FIG. 3 illustrates three power source wires 52. The signal wire 53 is an electrical wire in which a covering 53b is formed around a core wire 53a. The signal wire 53 is a wire transmitting a signal, and is a signal wire for a sensor 28a (refer to FIG. 1) or control, for example, and FIG. 3 illustrates two signal wires 53. Larger current may flow in the power source wire 52 than that in the signal wire 53, thus the core wire 53a is thinner than the core wire 52a. The whole signal wire 53 is also thinner than the power source wire 52. The wiring member 50 may include an optical fiber cable in place of or in addition to the power source wire 52 and the signal wire 53. It is also applicable that both the first wire-like transmission member 52 and the second wire-like transmission member 53 are the power source wire or the signal wire, and the former is thinner than the latter.

The plurality of wire-like transmission members (herein, the power source wire 52 and the signal wire 53) may be collected together. Any configuration is applicable to the configuration of collecting the power source wire 52 and the signal wire 53 together. For example, the power source wire 52 and the signal wire 53 may be collected together by a protection part. For example, the protection part may be a corrugate tube, an adhesive tape helically wound, a sheath extrusion covered to cover the power source wire 52 and the signal wire 53, or a resin or metal tube. The power source wire 52 and the signal wire 53 need not be collected together by the protection part, for example, along a whole longitudinal direction thereof. For example, it is also applicable that the protection part described above is omitted, and the power source wire 52 and the signal wire 53 are collected together by a bracket supporting the wiring member 50 in a constant position. The bracket herein may be the support member 60. Indicated herein is an example that the plurality of power source wires 52 and the signal wire 53 are collected together in the upper support part 62 and the lower support part 64.

Any shape is applicable as a transverse-sectional outer shape of the wiring member 50. FIG. 3 illustrates an example that the plurality of power source wires 52 are collected in a parallel state, the signal wire 53 is collected on one side in a parallel direction thereof, and an outer shape of the transverse-sectional surface of the wiring member 50 forms a flat shape. The outer shape of the transverse-sectional surface of the wiring member 50 may be a circular shape or an oval shape, for example. The transverse-sectional surface is a cross-sectional surface in a plane perpendicular to an axis of the wiring member 50.

One end portion of the wiring member 50 may be connector-connected to the vehicle body side apparatus 18. The wiring member 50 may be directly drawn from the vehicle body side apparatus 18. One end portion of the wiring member 50 may be connected to the vehicle body side apparatus 18 via the other wiring member.

The other end portion of the wiring member 50 may be connected to the vehicle wheel side apparatus 28 via the connector 51. The other end portion of the wiring member 50 may be directly connected to the vehicle wheel side apparatus 28 without intervention of the connector. The plurality of electrical wires may be branched and connected to the other positions, respectively, in the other portion of the wiring member 50.

The wiring member 50 may be routed to go through the steering rotation central axis X. Herein, the state where the wiring member 50 goes through the steering rotation central axis X indicates that there is a positional relationship that the steering rotation central axis X goes through an area in a minimum inclusion circle C in at least one transverse-sectional surface of the wiring member 50 in the longitudinal direction. The minimum inclusion circle C is a minimum circle which can include a portion of the wiring member 50 appearing in the transverse-sectional surface. For example, when the transverse-sectional shape of the wiring member 50 is a circular shape, an outer circle of the wiring member 50 appearing in the transverse-sectional surface is the minimum inclusion circle C. The case where the steering rotation central axis X goes through the area in the minimum inclusion circle C includes a case where the steering rotation central axis X goes through a boundary line of the minimum inclusion circle.

It is sufficient that the steering rotation central axis X goes through the area in the minimum inclusion circle C, thus the case where the wiring member 50 goes through the steering rotation central axis X includes a case where the wiring member 50 intersects with the steering rotation central axis X and a case where a part of the wiring member 50 is in a state of extending along the steering rotation central axis X. FIG. 1 illustrates an example that a part 50a of the wiring member 50 is in a state of extending along the steering rotation central axis X. It is sufficient that the steering rotation central axis X goes through the minimum inclusion circle C, thus the central axis of the wiring member 50 and the steering rotation central axis X need not coincide with each other in a portion of the wiring member 50 extending along the steering rotation central axis X.

That is to say, any positional relationship is applicable as long as the steering rotation central axis X goes through the area in the minimum inclusion circle C in the transverse-sectional surface of the wiring member 50 in a portion of the wiring member 50 going through the steering rotation central axis X (intersecting portion) or a portion of the wiring member 50 extending along the steering rotation central axis X.

It is preferable to increase a length of the portion of the wiring member 50 extending along the steering rotation central axis X to suppress bending deformation of the wiring member 50. The state where the support member 60 supports the wiring member 50 so that the wiring member 50 goes through the steering rotation central axis X includes both cases where the wiring member 50 can be moved and cannot be moved along an extension direction of the steering rotation central axis X while going through the steering rotation central axis X.

The wiring member 50 is not necessarily routed to go through the steering rotation central axis X. The wiring member 50 may be routed to pass through a position away from the steering rotation central axis X. Also in this case, at least a part of the wiring member 50 is preferably parallel to the steering rotation central axis X. However, the wiring member 50 does not necessarily extend along a direction parallel to the steering rotation central axis X.

The support member 60 supports the wiring member 50 so that the first wire-like transmission member 52 (the power source wire 52 herein) is located closer to the steering rotation central axis X than the second wire-like transmission member 53 (the signal wire 53 herein) in at least a part of the wiring member 50. Any member is applicable as the support member 60 as long as it supports the wiring member 50 in the state described above, and a configuration therefor is not particularly limited. The support member may be a single support member, or may include a plurality of support parts. The support member may be supported on a side of the vehicle body 10 or a side of the vehicle wheel 20. Herein, the state where the support member is supported on the side of the vehicle body 10 indicates that the support member is supported in a portion which is not rotated even when the vehicle wheel 20 is rotated around the steering rotation central axis X. For example, applied is a case where the support member is supported by the dumper 36 or the lower arm 32 described above. The state where the support member 60 is supported on the side of the vehicle wheel 20 indicates that the support member 60 is supported in a portion rotated in accordance with a rotation of the vehicle wheel 20 around the steering rotation central axis X. For example, applied is a case where the support member is supported by the upper knuckle part 25 or the lower knuckle part 26 described above.

In the present embodiment, the support member 60 includes an upper support part 62 and a lower support part 64. The lower support part 64 is provided to a lower side of the upper support part 62. The wiring member 50 is supported by the upper support part 62 and the lower support part 64, thus the wiring member 50 goes through the steering rotation central axis X between the upper support part 62 and the lower support part 64.

More specifically, the upper support part 62 and the lower support part 64 are provided between a tip end portion of the upper knuckle part 25 and a tip end portion of the lower knuckle part 26. The tip end portion of the upper knuckle part 25, the upper support part 62, the lower support part 64, and the tip end portion of the lower knuckle part 26 are arranged in this order from an upper side to a lower side at intervals along the steering rotation central axis X. The upper support part 62 and the lower support part 64 are supported on the tip end portions of the dumper 36 by an extension support part 61. The extension support part 61 detours from the tip end portion of the upper knuckle part 25 while being directed from the lower end portion of the dumper 36 to the lower side in a posture in parallel to the steering rotation central axis X. The extension support part 61 may be fixed to the dumper 36 by welding or screwing, for example. A tip end portion of the extension support part 61 reaches a near side of the tip end portion of the lower knuckle part 26. The upper support part 62 and the lower support part 64 are supported by the dumper 36 via the extension support part 61, thus do not follow the rotation of the vehicle wheel 20 around the steering rotation central axis X. Accordingly, the upper support part 62 and the lower support part 64 are supported on the side of the vehicle body 10.

The upper support part 62 is supported on an intermediate portion in an extension direction of the extension support part 61. The upper support part 62 may be integrally formed with the extension support part 61, or may also be fixed to the extension support part 61 by welding or screwing, for example. The upper support part 62 is provided in a position on the lower side away from the tip end portion of the upper knuckle part 25 along the steering rotation central axis X. In this arrangement position, the upper support part 62 supports a part of the wiring member 50 at a position on the steering rotation central axis X. It is sufficient that the upper support part 62 supports a part of the wiring member 50 in a constant position. For example, the upper support part 62 may be an annular member having a hole into which the wiring member 50 is inserted. The upper support part 62 may have a configuration that a pair of sandwiching pieces are screwed while sandwiching a part of the wiring member 50. The upper support part 62 may have a configuration of having a swaging piece swaged and fixed to a part of the wiring member 50. The upper support part 62 may support a part of the wiring member 50 while not allowing a rotation thereof.

The lower support part 64 is supported on the tip end portion of the extension support part 61. The lower support part 64 may be integrally formed with the extension support part 61, or may also be fixed to the extension support part 61 by welding or screwing, for example. The lower support part 64 is provided in a position on the lower side away from the upper support part 62 and on the upper side away from the tip end portion of the lower knuckle part 26 along the steering rotation central axis X. In this arrangement position, the lower support part 64 supports a part of the wiring member 50 at a position on the steering rotation central axis X.

The lower support part 64 may have a configuration of supporting the wiring member 50 while allowing the rotation thereof around the steering rotation central axis X.

Herein, the lower support part 64 includes an outer side body part 64a and an inner side rotation support part 64b. The outer side body part 64a is supported on the dumper 36 by the extension support part 61 described above. Thus, the outer side body part 64a is a portion which is not rotated even when the vehicle wheel 20 is rotated around the steering rotation central axis X. The inner side rotation support part 64b is rotatably supported on the outer side body part 64a. Adoptable as the lower support part 64 are various types of bearing structure such as a rolling bearing or a fluid bearing, for example. The inner side rotation support part 64b may support the wiring member 50 while allowing the rotation thereof, or may support the wiring member 50 while not allowing the rotation thereof. In the latter case, when the wiring member 50 is twisted, the inner side rotation support part 64b is rotated with respect to the outer side body part 64a, thus friction, for example, hardly occurs between the wiring member 50 and the inner side rotation support part 64b. The arrangement in the wiring member 50 is hardly disordered in the inner side rotation support part 64b. Herein, a holding hole having a shape similar to the transverse-sectional shape of the wiring member 50 is formed in the inner side rotation support part 64b. The wiring member 50 is held in a state of not being rotatable on the inner side rotation support part 64b. The wiring member 50 can be rotated with respect to the outer side body part 64a together with the inner side rotation support part 64b.

The lower support part 64 may be formed into an annular shape having an inner diameter larger than the minimum inclusion circle C of the wiring member 50. In this case, the wiring member 50 can be rotated in the hole in the lower support part 64.

The wiring member 50 extends from the vehicle body side apparatus 18 in the vehicle body 10 to pass through the fender apron 16, and is led toward the tip end portion of the upper knuckle part 25. The wiring member 50 goes through an area between the tip end portion of the upper knuckle part 25 and the upper support part 62, and is supported on the steering rotation central axis X by the upper support part 62. Furthermore, the wiring member 50 is led toward the lower support part 64, and is supported on the steering rotation central axis X by the lower support part 64. A portion of the wiring member 50 between the upper support part 62 and the lower support part 64 is a portion supported along the steering rotation central axis X. Furthermore, the wiring member 50 goes through the area between the lower support part 64 and the tip end portion of the lower knuckle part 26 to extend toward the vehicle wheel side apparatus 28, and is connected to the vehicle wheel side apparatus 28 via the connector 51.

When the lower support part 64 rotatably supports the wiring member 50, twist of the wiring member 50 caused by the rotation of the vehicle wheel 20 around the steering rotation central axis X can be transmitted to the portion of the wiring member 50 between the lower support part 64 and the upper support part 62. When the upper support part 62 supports the wiring member 50 while not allowing the rotation of the wiring member 50, the twist of the wiring member 50 is hardly transmitted to the portion of the wiring member 50 on the side of the vehicle body 10 compared with the upper support part 62.

In the present embodiment, the support member 60 supports the wiring member 50 so that the power source wire 52 is located closer to the steering rotation central axis X than the signal wire 53 in a portion of the wiring member 50 extending along the steering rotation central axis X. A distance of each wire-like transmission member from the steering rotation central axis X may be determined by a magnitude of the distance from the steering rotation central axis X to the central axis of the wire-like transmission member.

More specifically, three power source wires 52 are collected in a parallel state while having contact with each other, and two signal wires 53 are provided to one side thereof. The support member 60 supports the wiring member 50 so that the steering rotation central axis X coincides with the central axis of the power source wire 52 in a center of three power source wires 52 parallelly arranged. Two signal wires 53 are disposed on one side of three power source wires 52 parallelly disposed, thus a distance from two signal wires 53 to the steering rotation central axis X is larger than each distance from three power source wires 52 to the steering rotation central axis X. Accordingly, each power source wire 52 is located closer to the steering rotation central axis X than each signal wire 53.

The plurality of power source wires 52 may have the other configuration such as a form in which they are collected to be disposed in each vertex of a regular polygon (for example, a regular triangle), for example. The plurality of power source wires 52 may be stranded. The plurality of signal wires 53 need not be deflected to a part of a surrounding area of the power source wire 52, but may be diffused around the power source wire 52. The plurality of signal wires 53 may be collected in a state parallel to each other, or may also be stranded.

According to the undercarriage wiring module 40 and the routing structure 30 of the undercarriage wiring module having the above configurations, the power source wire 52 is provided closer than the signal wire 53 in at least a part of the wiring member 50. Thus, when the vehicle wheel 20 is rotated around the steering rotation central axis X, the thick power source wire 52 is hardly bended and deformed. The thick power source wire 52 has a physical property of being hardly bended, and is hardly bended and deformed, thus deterioration caused by the bending deformation hardly occurs. When the vehicle wheel 20 is rotated around the steering rotation central axis X, the thin signal wire 53 is bended and deformed more easily than the power source wire 52. The thin signal wire 53 has a physical property of being easily bended, and even when it is bended and deformed, deterioration caused by the bending deformation hardly occurs. Accordingly, the resistance of the undercarriage wiring module to the repetitive bending deformation is further improved as the whole undercarriage wiring module 40.

The power source wire 52 needs not be located closer to the steering rotation central axis X than the signal wire 53 in the whole region of the wiring member 50. However, it is sufficient that the power source wire 52 is located closer to the steering rotation central axis X than the signal wire 53 in a portion of the wiring member 50 parallel to the steering rotation central axis X. Accordingly, when the vehicle wheel 20 is rotated around the steering rotation central axis X, the power source wire 52 close to the steering rotation central axis X is easily bended and deformed in a portion of the wiring member 50 parallel to the steering rotation central axis X.

It is sufficient that the support member 60 supports the wiring member 50 so that at least a part of the wiring member 50 extends along the steering rotation central axis X, and the power source wire 52 is located closer to the steering rotation central axis X than the signal wire 53 in a portion of the wiring member 50 extending along the steering rotation central axis X.

In this case, at least a part of the wiring member 50 is supported at the steering rotation central axis X. Thus, when the vehicle wheel 20 is rotated with steering, suppressed is a variation of distance from a portion of the wiring member 50 located in the steering rotation central axis X to the vehicle wheel side apparatus 28. Accordingly, bending deformation of the wiring member 50 is suppressed in the case where the vehicle wheel 20 is rotated with steering. A portion of the wiring member 50 extending along the steering rotation central axis X can be easily twisted. Accordingly, deformation positions caused by the rotation of the vehicle wheel 20 around the steering rotation central axis X are diffused to a wide range, and the wiring member 50 has a longer life.

A more specific example is described with reference to FIG. 3. In FIG. 3, the vehicle wheel side apparatus 28 and the wiring member 50 directed to the vehicle wheel side apparatus 28 in a case where the vehicle body keeps traveling straight are illustrated by solid lines, and the vehicle wheel side apparatus 28 and the wiring member 50 directed to the vehicle wheel side apparatus 28 in a case where the vehicle body turns are illustrated by alternate long and two short dashes lines. As illustrated in FIG. 3, when the vehicle wheel 20 is rotated around the steering rotation central axis X, the vehicle wheel side apparatus 28 as a connection destination of the wiring member 50 is rotated around the steering rotation central axis X. Thus, a distance from the steering rotation central axis X and the vehicle wheel side apparatus 28 is kept as constant as possible. The wiring member 50 goes through the steering rotation central axis X, and is connected to the vehicle wheel side apparatus 28, thus even when the vehicle wheel 20 is rotated around the steering rotation central axis X, a portion of the wiring member 50 going through the steering rotation central axis X to a portion thereof reaching the vehicle wheel side apparatus 28 keeps having a length L as constant as possible. Thus, force of expanding and shrinking the wiring member 50 hardly acts on the wiring member 50 when the vehicle wheel 20 is rotated with steering, and bending deformation of the wiring member 50 is suppressed.

A portion of the wiring member 50 extending along the steering rotation central axis X is twisted, thereby being able to follow the rotation of the vehicle wheel 20. In this case, particularly, the thick power source wire 52 is twisted, thereby being able to follow the rotation of the vehicle wheel 20, thus is hardly deteriorated. Thus, the resistance to the repetitive deformation is further improved as the whole undercarriage wiring module 40.

It is sufficient that the twist of the wiring member 50 caused by the rotation of the vehicle wheel 20 around the steering rotation central axis X is transmitted to the upper side of the support position of the wiring member 50 supported by the lower support part 64 so that the wiring member 50 is twisted and deformed between the upper support part 62 and the lower support part 64. For example, as described above, the lower support part 64 may have the configuration of supporting the wiring member 50 while allowing the rotation thereof around the steering rotation central axis X. Accordingly, the portion of the wiring member 50 between the upper support part 62 and the lower support part 64 can be easily twisted and deformed in accordance with the rotation of the vehicle wheel 20 by the steering.

The support member 60 may support the wiring member 50 so that the twist of the wiring member 50 is not transmitted from the support position supported by the support member 60 to the side of the vehicle body 10. For example, it is also applicable that the upper support part 62 is supported on the side of the vehicle body 10 such as the tip end portion of the dumper 36 and the upper support part 62 supports the wiring member 50 while not allowing the rotation of the wiring member 50 as with the embodiment described above.

As described above, it is applicable that the first wire-like transmission member 52 is the power source wire 52, and the second wire-like transmission member 53 is the signal wire 53. Accordingly, achievable is a layout that the power source wire 52 which is thick and hardy bended is hardly bended and deformed in accordance with the rotation of the vehicle wheel and the signal wire 53 which is thin and can be easily bended is bended and deformed in accordance with the rotation of the vehicle wheel 20, and the resistance of the undercarriage wiring module 40 to the repetitive deformation can be further improved as the whole undercarriage wiring module 40.

The power source wire 52 is disposed in a position where the power source wire 52 is hardly bended and deformed in accordance with the rotation of the vehicle wheel, thus durability of the power source wire necessary to travel, for example, more than the signal by a sensor, for example, can be further improved. Accordingly, travel continuity of the vehicle is further improved.

### [Modification Example]

Various modification examples are considered as an example of locating the power source wire 52 as the first wire-like transmission member 52 closer to the steering rotation central axis X than the signal wire 53 as the second wire-like transmission member 53.

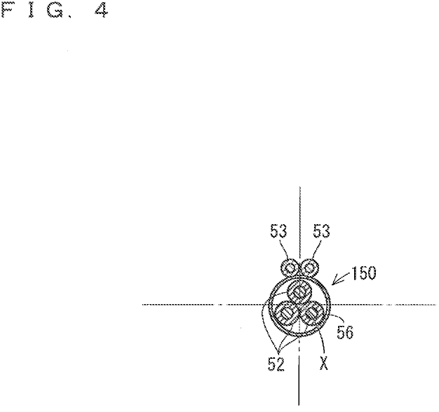

For example, the plurality of power source wires 52 may be covered by a protection part 56 in a bundled state as with a wiring member 150 illustrated in FIG. 4. The protection part 56 may be a corrugate tube, an adhesive tape helically wound, a sheath extrusion covered to cover the power source wire 52 and the signal wire 53, or resin or a metal tube. The plurality of power source wire 52 and the plurality of signal wires 53 are collected so that the plurality of signal wires 53 extend along an outer periphery of the protection part 56. This collection state may be kept by the upper support part 62 and the lower support part 64 described above. In this case, the steering rotation central axis X is set in a center of a cable made up of the plurality of power source wires 52 collected by the protection part 56. In this case, the plurality of power source wires 52 are twisted and deformed in the protection part 56 by the rotation of the vehicle wheel 20 around the steering rotation central axis X, and the plurality of signal wires 53 are deformed on a side of the outer periphery of the protection part 56. As described in the embodiment described above, the plurality of power source wires 52 is located close to the steering rotation central axis X, thus the bending deformation thereof occurs in small degree. The plurality of signal wires 53 is located away from the steering rotation central axis X, thus is bended and deformed more than the power source wire 52. As described in the embodiment described above, the resistance to the repetitive deformation is further improved as the whole undercarriage wiring module.

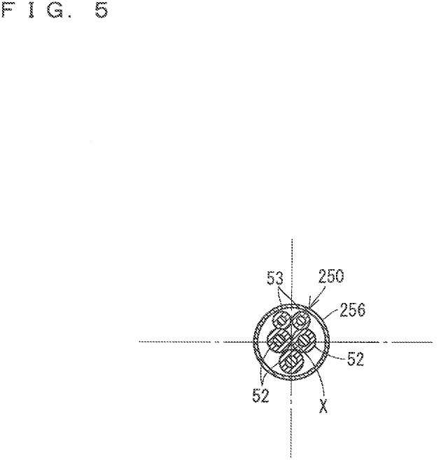

For example, the plurality of (three herein) power source wires 52 and the plurality of (two herein) signal wires 53 may be covered by a protection part 256 in a bundled state as with a wiring member 250 illustrated in FIG. 5. The protection part 256 may be a corrugate tube, an adhesive tape helically wound, a sheath extrusion covered to cover the power source wire 52 and the signal wire 53, or resin or a metal tube in the manner similar to the protection part 56.

The plurality of power source wires 52 are collected together. The plurality of signal wires 53 extend around the plurality of power source wires 52 collected together. The plurality of signal wires 53 may be collected together, or may be diffused around the plurality of power source wires 52 collected together. In this case, the steering rotation central axis X is set in a position closer to the plurality of power source wires 52 than the plurality of signal wires 53. In other words, the steering rotation central axis X is located closer to a side of the plurality of power source wires 52 than the plurality of signal wires 53. Herein, the steering rotation central axis X is set to a central axis of the wiring member 250. The plurality of power source wires 52 are thinner than the signal wires 53 and occupy a position close to the center of the wiring member 50, thus are located closer to the steering rotation central axis X than the plurality of signal wires 53. Thus, the resistance to the repetitive deformation is further improved as the whole undercarriage wiring module in the manner similar to the embodiment described above.

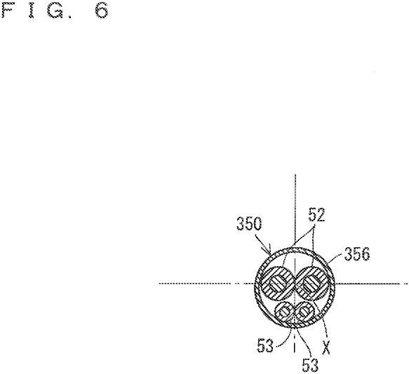

The number of the power source wires 52 and the number of the signal wires 53 are optionally set. For example, two power source wires 52 and two signal wires 53 may be covered by a protection part 356 in a bundled state as with a wiring member 350 illustrated in FIG. 6. In this case, for example, the steering rotation central axis X is set between two power source wires 52, and the signal wires 53 are provided in positions away from two power source wires 52 and the steering rotation central axis X. Also in this case, the resistance to the repetitive deformation is further improved as the whole undercarriage wiring module in the manner similar to the embodiment described above.

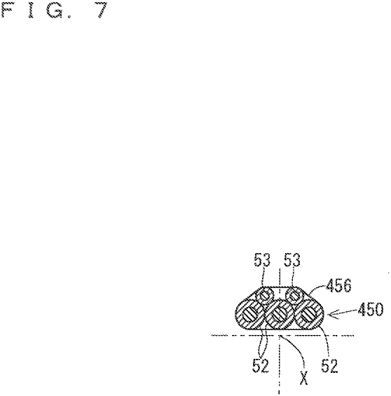

For example, it is also applicable that the plurality of power source wires 52 are collected in a parallel state and the signal wires 53 are provided to one side in a thickness direction of the plurality of power source wires 52 as with a wiring member 450 illustrated in FIG. 7. The plurality of power source wires 52 and the plurality of signal wires 53 may be covered by a protection part 456 in the manner similar to the protection part 56. In this case, the steering rotation central axis X is set in a position closer to the plurality of power source wires 52 than the plurality of signal wires 53. Herein, the steering rotation central axis X is set in a position on an opposite side of the plurality of power source wires 52 parallel to each other from the signal wires 53. The plurality of power source wires 52 are disposed between the signal wires 53 and the steering rotation central axis X, thus the plurality of power source wires 52 are located closer to the steering rotation central axis X than the plurality of signal wires 53. Thus, the resistance to the repetitive deformation is further improved as the whole undercarriage wiring module in the manner similar to the embodiment described above.

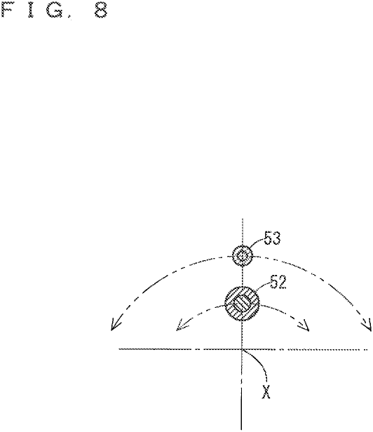

When at least one first wire-like transmission member 52 is provided closer to the steering rotation central axis X than at least one second wire-like transmission member 53 as illustrated in FIG. 8, the resistance to the repetitive deformation is further improved as the whole undercarriage wiring module. Thus, the first wire-like transmission member 52 and the second wire-like transmission member 53 may be provided in positions away from the steering rotation central axis X. The reason is that, also in this case, when the vehicle wheel 20 is rotated around the steering rotation central axis X, bending deformation of the first wire-like transmission member 52 closer to the steering rotation central axis X is suppressed compared with a bending deformation amount of the second wire-like transmission member 53 farther away from the steering rotation central axis X.

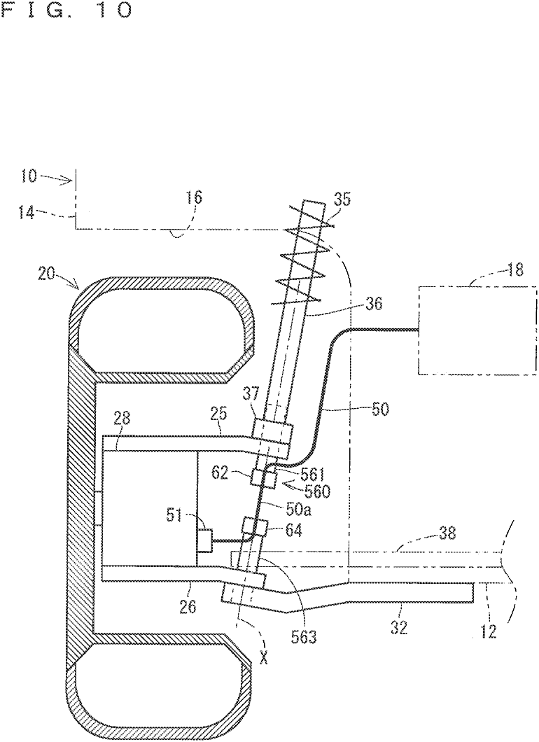

As illustrated in FIG. 10, the plurality of first wire-like transmission members 52 may be bundled so that adjacent ones thereof have contact with each other. In FIG. 10, three first wire-like transmission members 52 are bundled so that a center of each of three first wire-like transmission members 52 is disposed in a position of a vertex of a regular triangle. The steering rotation central axis X is located in a geometric center of a polygon (a triangle herein) drawn by the centers of three first wire-like transmission members 52 herein. The thin second wire-like transmission member 53 is preferably fitted in a gap 610 between the plurality of first wire-like transmission members 52 in a position farther away from the steering rotation central axis X than the plurality of first wire-like transmission members 52. Herein, three gaps 610 are formed around three first wire-like transmission members 52, and three second wire-like transmission members 53 are fitted in the gaps 610 described above. In FIG. 10, the gap 610 having a triangular groove-like shape in a cross-sectional view is formed between the first wire-like transmission members 52 adjacent to each other. A portion of the second wire-like transmission member 53 on a side of the steering rotation central axis X is housed in the gap 610. In the state described above, outer peripheries of the first wire-like transmission member 52 and the second wire-like transmission member 53 are covered by a protection part 656 such as a sheath, thus the bundled state described above is maintained.

According to the present example, the plurality of first wire-like transmission members 52 can be disposed closer to the steering rotation central axis X than the second wire-like transmission member 53 while thinning a wiring member 600.

When the wiring member includes plural types of wire-like transmission member having thicknesses different from each other, it is also applicable that one or a plurality of thickest wire-like transmission members are the first wire-like transmission members and one or a plurality of thinnest wire-like transmission members are the second wire-like transmission members.

FIG. 10 is a schematic cross-sectional view illustrating a support member 560 according to a modification example. In the present modification example, an extension support part 561 corresponding to the extension support part 61 supports the upper support part 62 and does not support the lower support part 64 in the support member 560.

The lower support part 64 is supported on the lower knuckle part 26. That is to say, an extension support part 563 is provided to be directed to an upper side along the steering rotation central axis X from the tip end portion of the lower knuckle part 26. The lower support part 64 is supported on the tip end portion of the extension support part 563. The extension support part 563 may be welded or screwed to the lower knuckle part 26 and the lower support part 64, or may also be integrally formed therewith.

In the present modification example, the lower support part 64 is supported on the lower knuckle part 26 via the extension support part 563. Thus, when the vehicle wheel is rotated around the steering rotation central axis X, the lower support part 64 is also rotated around the steering rotation central axis X. Thus, even when the lower support part 64 supports the wiring member 50 while not allowing the rotation thereof in the manner similar to the support structure by the upper support part 62, the wiring member 50 can be twisted between the upper support part 62 and the lower support part 64.

In this case, it is sufficient that the lower support part 64 is supported on the side of the vehicle wheel 20. For example, the lower support part 64 may be supported on the vehicle wheel side apparatus 28, for example, via the other support member. That is to say, the lower support part 64 is rotated around the steering rotation central axis X, thus may also be directly or indirectly supported in a portion which is not rotated around the travel rotational axis.

Each configuration described in the embodiment and each modification example can be appropriately combined as long as they are not contradictory.

### EXPLANATION OF REFERENCE SIGNS

10 vehicle body
12 floor part
14 body part
16 fender apron
18 vehicle body side apparatus
19 steering wheel
19a steering shaft
19b transmission mechanism
20 vehicle wheel
22 wheel
22a disk part
22b tire attachment part
24 tire
25 upper knuckle part
26 lower knuckle part
26a arm part
28 vehicle wheel side apparatus
28a shaft
30 routing structure
32 lower arm
33 bearing part
35 spring
36 dumper
37 bearing part
38 tie rod
40 undercarriage wiring module
50 wiring member
50a part of wiring member
51 connector
52 power source wire (first wire-like transmission member)
52a core wire
52b covering
53 signal wire (second wire-like transmission member)
53a core wire
53b covering
56 protection part
60 support member
61 extension support part
62 upper support part
64 lower support part
64a outer side body part
64b inner side rotation support part
150 wiring member
250 wiring member
256 protection part
350 wiring member
356 protection part
450 wiring member
456 protection part
560 support member
561 extension support part
563 extension support part
600 wiring member
610 gap
656 protection part
C minimum inclusion circle
X steering rotation central axis

1. An undercarriage wiring module, comprising:
a wiring member connecting a vehicle body side apparatus and a vehicle wheel side apparatus; and
a support member supporting the wiring member, wherein
the wiring member includes at least one first wire-like transmission member and a second wire-like transmission member thinner than the first wire-like transmission member, and
the support member supports the wiring member so that the first wire-like transmission member is located closer to a steering rotation central axis than the second wire-like transmission member in at least a part of the wiring member.

2. The undercarriage wiring module according to claim 1, wherein
the support member supports the wiring member so that at least a part of the wiring member is parallel to the steering rotation central axis, and
the first wire-like transmission member is located closer to the steering rotation central axis than the second wire-like transmission member in a portion of the wiring member parallel to the steering rotation central axis.

3. The undercarriage wiring module according to claim 1, wherein
the support member supports the wiring member so that at least a part of the wiring member extends along the steering rotation central axis, and
the first wire-like transmission member is located closer to the steering rotation central axis than the second wire-like transmission member in a portion of the wiring member extending along the steering rotation central axis.

4. The undercarriage wiring module according to claim 3, wherein
the steering rotation central axis passes through an area in a minimum inclusion circle in a transverse-sectional surface of the wiring member in a portion of the wiring member extending along the steering rotation central axis.

5. The undercarriage wiring module according to claim 1, wherein
the first wire-like transmission member is a power source wire, and the second wire-like transmission member is a signal wire.

6. The undercarriage wiring module according to claim 1, wherein
the wiring member includes the plurality of first wire-like transmission members, and
the plurality of first wire-like transmission members are bundled in at least a part of the wiring member, and the second wire-like transmission member is fitted in a gap between the plurality of first wire-like transmission members in a position farther away from the plurality of first wire-like transmission members in relation to the steering rotation central axis.

7. A routing structure of an undercarriage wiring module, comprising:
a wiring member connecting a vehicle body side apparatus and a vehicle wheel side apparatus; and
a part of the wiring member is routed to go through a steering rotation central axis.
